(19) United States
(12) Patent Application Publication
(10) Pub. No.: US 2003/0112048 A1
(43) Pub. Date: Jun. 19, 2003

(54) Pulse generator circuit and corresponding micro-electronic component

(76) Inventor: Bernard Coloma, Nantes (FR)

Correspondence Address: Robert M. Angus, Westman, Champlin & Kelly, International Centre, Suite 1600, 900 Second Avenue South, Minneapolis, MN, 55402-3319, US

(21) Appl. No.: 10/298,250

(22) Filed: Nov. 15, 2002

(30) Foreign Application Priority Data
Nov. 19, 2001 (FR) FR01 14965

(51) Int. Cl. G06F 1/04

(52) U.S. Cl. 327/291

(57) ABSTRACT

The invention relates to a micro-electronic pulse generator circuit, delivering a pulse at an output as a function of two input signals, a command signal (PH_IN) and a control signal (ENABLE), including a first and a second memory point and a time-delay module mounted in series, said time-delay module delivering said pulse as an output, said memory points each including reset to zero means controlled by said command signal and said control signal respectively.

The field of the invention is that of micro-electronic devices. More exactly, the invention relates to calibrated pulse generation, in respect of controlling or implementing micro-electronic components such as, for example memories. In this case, pulse generation is necessary in order to control read or write memory access.

Clearly, the invention is not restricted to this application, but may be used in all circumstances where calibrated pulses are necessary.

More precisely, the invention relates to calibrated pulse generation from two input signals, a control pulse, or command signal (hereinafter referred to as PH_IN), and a control signal (hereinafter referred to as ENABLE). The operation of a calibrated pulse generator is then as follows: it generates a calibrated pulse at the end of a control pulse, and controls the expected stop of the generated pulse, under the action of the control signal or on receipt of a new control pulse.

According to the prior art, calibrated pulse generation is obtained by using a combinational system, consisting of logic gates.

A major drawback of using a block consisting of logic gates is that a block of this kind is difficult to calibrate, and is very dependent on variations in the manufacturing process and in temperature. Propagation delay deviations within the different logic gate layers are consequently not effectively controlled, which may lead to the appearance of interference pulses.

These problems become of course all the more significant the more specialised the technology and/or the faster the basic clock.

These interferences pulses can be particularly harmful. For example in the case of a memory, they may lead to the ill-timed writing of undifferentiated random data, and therefore to interfering with or interrupting the operation of the device equipped with this memory.

The purpose of the invention is therefore to overcome these drawbacks of the prior art.

More exactly, the purpose of the invention is to provide, from a control pulse and a control signal, a pulse generator circuit that does not produce output interference pulses.

Another purpose of the invention is to provide a circuit of this kind that is straightforward, in terms of the number of components and the silicon surface, and that can be easily manufactured and adapted to a micro-electronic component.

In particular, a purpose of the invention is to provide a circuit of this kind, requiring a reduced number of transistors, relative to logic systems.

Yet another purpose of the invention is to provide a circuit of this kind, that can be adapted to any type of asynchronous system, particularly memories, and in particular high-speed memories.

These purposes, as well as others which will emerge subsequently, are fulfilled by using a micro-electronic pulse generator circuit, delivering a pulse at an output as a function of two input signals, a command signal (PH_IN) and a control signal (ENABLE).

According to the invention, this circuit includes a first and a second memory point and a time-delay module mounted in series, said time-delay module delivering said pulse as an output, said memory points each including reset to zero means controlled by said command signal and said control signal respectively.

A circuit of this kind, that is based on an analogue and not now a logic approach, proves to be particularly effective, as will be seen below, and requires only a small number of transistors. It effectively eliminates the generation of interference pulses, due to propagation delays in logic gates.

To advantage, said memory points are identical memory points, mounted in phase opposition.

Preferentially, said reset to zero means are controlled in such a way as to position said circuit in a pre-set state when it is initialised, and to interrupt the generation of a pulse as soon as one of said input signals takes a pre-set value.

To advantage:

means of resetting said first memory point to zero are controlled by said inverted command signal;

means of resetting said second memory point to zero are controlled by said control signal.

According to a preferential embodiment, said memory points each include two looped inverters, followed by a third inverter supplying said memory point output.

To advantage, access to each of said memory points is via a Nmos/Pmos pass gate. Preferentially, said reset to zero means include a Nmos transistor.

According to an advantageous aspect of the invention, said time-delay module is activated by a rising edge at the output of said second memory point.

Preferentially, said time-delay module includes an inverter time-delay element, a NAND gate and an inverter, delivering said pulse.

The invention also relates to the micro-electronic components, including at least one micro-electronic pulse generator circuit as described above.

Said circuits may particularly control read and/or write memory access.

Other characteristics and advantages of the invention will emerge more clearly from reading the following description of one preferential embodiment of the invention, given purely by way of illustration and non-restrictively, and the appended drawings, among which:

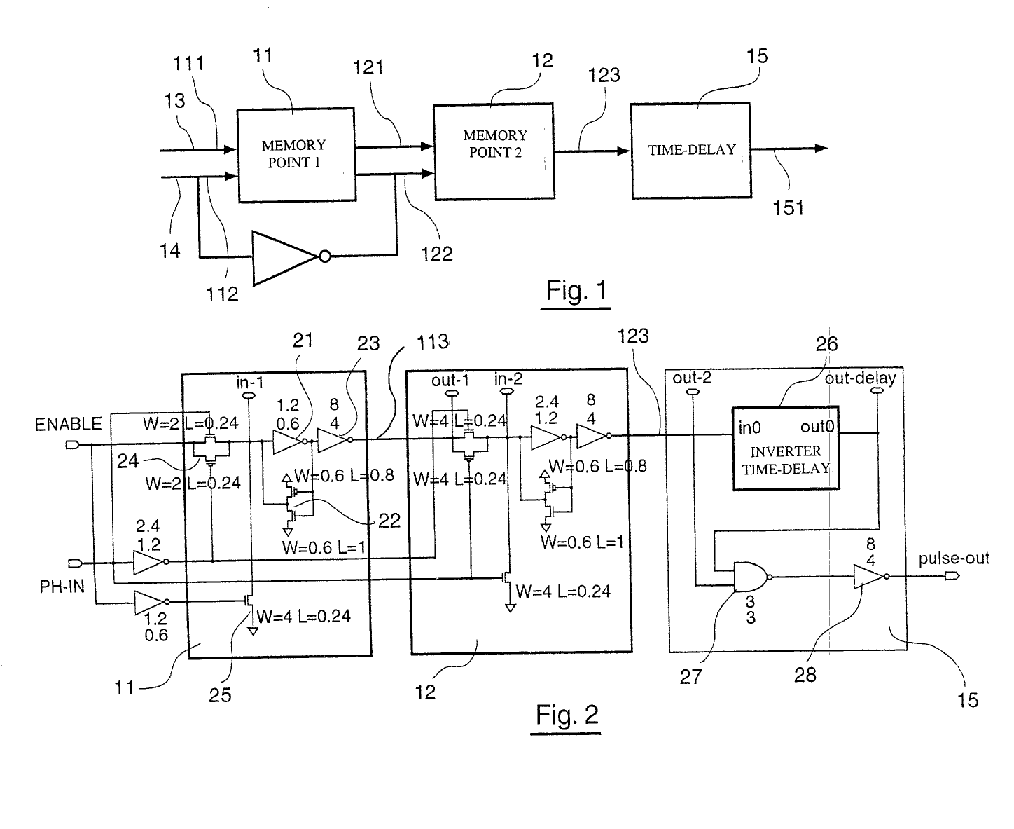

FIG. 1 is a block diagram showing the general principle of the invention;

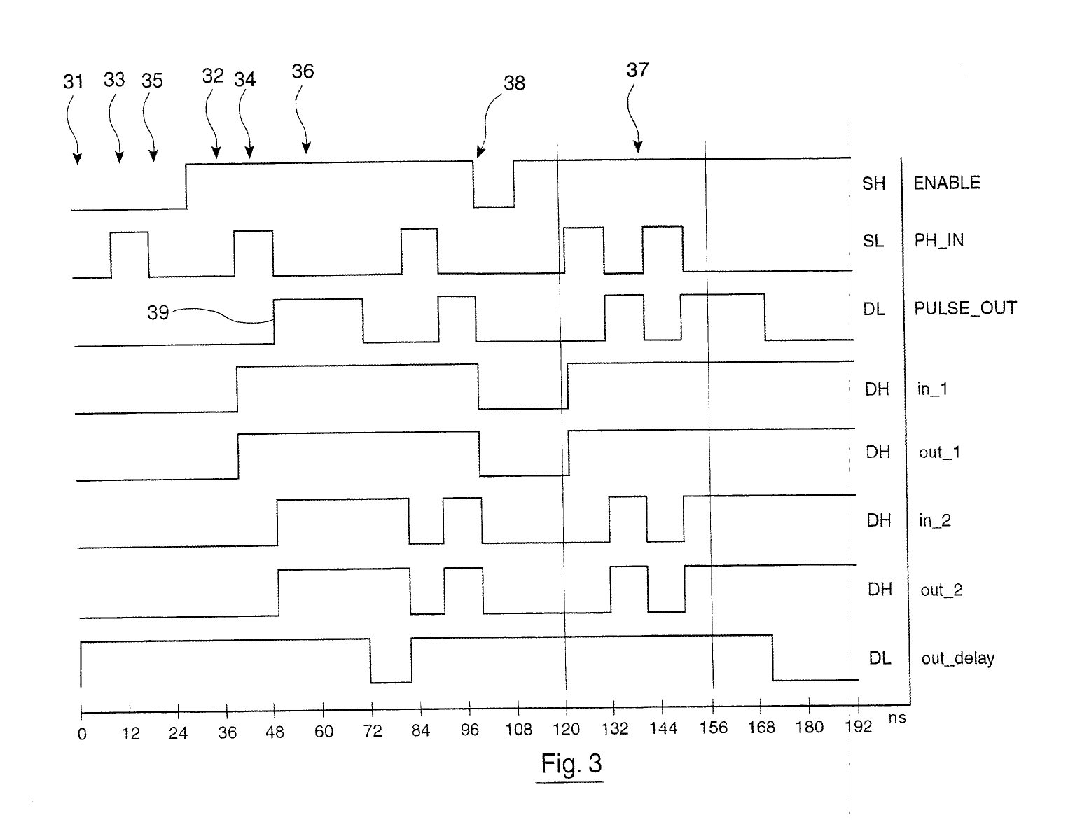

FIG. 2 shows in detail one embodiment of the diagram in FIG. 1;

FIG. 3 shows a simulation of the main signals of the circuit in FIG. 2.

As explained above, to avoid the creation of interference pulses present in the combinational circuits, generated by propagation delay differences through different logic layers, the invention is based on a totally different approach, namely a system based on two memory points and a time-delay module mounted in series, as is shown in FIG. 1.

Each memory point 11, 12 has a first input 111, 121 allowing it to be reset to 0 (memory point re-initialisation, or “reset”) and a second command input 112, 122.

The output 123 of the second memory point 12 acts on an output stage 15 including a time-delay block on an edge which delivers calibrated pulses as an output 151.

According to the embodiment described, the two memory points 11 and 12 are identical, and mounted in phase opposition. On system start-up, the control signal 14, or “reset”, allows this system to be positioned in its correct configuration. It also allows the generation of an output pulse to be stopped, as a function of the two input signals 13 and 14.

One particularity of this system is the re-initialisation (“reset”) control of the two memory points 11 and 12. The re-initialisation of the first memory point 11 is carried out by the inverted input signal 13, and the re-initialisation of the second memory point 12 is provided by the control signal 14.

Output pulse 151 duration is managed by the time-delay block. The output stage 15, consisting of this time-delay block and by logic gates, produces a time-delay on the rising front of the output signal 123 of the second memory point 12.

According to the embodiment shown in FIG. 2, each memory point 11, 12 includes two looped inverters 21, 22, followed by a third inverter 23 intended to re-establish the correct output polarity of the memory point (since the two memory points 11 and 12 are identical, only the first is described).

The memory point is accessed through a Nmos/Pmos “pass gate” 24. A Nmos transistor 25 allows the memory point to be reset, by acting on the inverter 21.

The output stage 15 includes an inverter time-delay block 26 on a rising edge of the output signal 123 of the second memory point 12, a NAND gate and an inverter 28. The time-delay block 26 is constituted by inverters and capacitors, and generates an RC delay, which is fixed in this embodiment, but could clearly be adjustable and/or programmable.

The time-delay block 26, which is known per se, is not described in detail. In the same way, the structure of the inverter 22 and the pass gate 24 are known. Reference may be made, where necessary, to FIG. 2, which is given in considerably more detail. Likewise, reference may be made to FIG. 2 in respect of all component connections.

The dimensions of the different transistors appearing in FIG. 2 are of course given simply by way of example.

There now follows a description of the operation of the circuit in FIG. 2, by means particularly of the simulation in FIG. 3. The signals shown are as follows:

the input pulse 13 is the PH_IN signal;

the control signal 14 is the ENABLE signal;

the output 151 of the block is the PULSE_OUT signal;

the input 111 of the first memory point 11 is the IN_{—}1 signal;

the output 113 of the first memory point 11 is the OUT_{—}1 signal;

the input 121 of the second memory point 12 is the IN_{—}2 signal;

the output 123 of the second memory point 12 is the OUT_{—}2 signal.

This terminology is found again in FIG. 2.

At initialisation (31), the ENABLE control signal is at 0: it resets the first memory point to 0. The input pulse PH_IN is at 0: it makes the input pass gate of the second memory point conducting. In this way the output 113 on the first memory point resets the second memory point 12 to 0 through the pass gate, which is conducting when PH_IN is at 0.

The two memory points are thus reset to 0, and the output is at 0 (no pulse generated).

When the ENABLE signal passes to 1 and PH_IN is at 0 (32), the re-initialisation of the first memory point 11 stops. However, the pass gate of the first memory point 11, 12 and the output 151 remain at 0.

When the PH_IN signal passes to 1 and ENABLE is at 0 (33), the pass gate of the first memory point 11 becomes conducting, and the pass gate of the second memory point 12 is non-conducting. Re-initialisation of the second memory point 12 is activated. Consequently, the first memory point 11 takes the value of the ENABLE signal, in other words 0.

When the PH_IN signal passes to 1 and ENABLE is at 1 (34), the pass gate of the first memory point 11 becomes conducting, and the pass gate of the second memory point 12 is non-conducting. Re-initialisation, the reset of the second memory point 12 is activated. The first memory point 11 takes the value of the ENABLE signal, in other words 1.

When the PH_IN signal passes to 0, the pass gate of the first memory point 11 is non-conducting, and the pass gate of the second memory point 12 becomes conducting. Re-initialisation of the second memory point 12 is de-activated. The second memory point 12 therefore takes the value of the output signal 113 of the first memory point 11, i.e.:

if ENABLE were equal to 0 (35), the value 0 is propagated from the first memory point 11 to the second 12, and there is no system output pulse creation,

if ENABLE were equal to 1 (36), the value 1 is propagated from the first memory point 11 to the second 12. There is then system output calibrated pulse creation 39.

During the creation of the calibrated pulse (previous aspect), pulse generation may be interrupted in the following two cases:

If PH_IN passes to 1 (37), then the second memory point 12 is reset to 0: the out_2 output returns to 0, the output pulse 15 ends.

If ENABLE passes to 0 (38), the first memory point 11 is reset to 0. The 0 is propagated to the second memory point 12 through the pass gate of the latter: the out_2 output returns to 0, and the output pulse 151 ends.

Clearly, other modes of implementation may be developed, within the framework of the invention.

1. A micro-electronic pulse generator circuit, delivering a pulse at an output as a function of two input signals, a command signal (PH_IN) and a control signal (ENABLE),
characterised in that it includes a first and a second memory point and a time-delay module mounted in series, said time-delay module delivering said pulse as an output,
said memory points each including reset to zero means controlled by said command signal and said control signal respectively.

2. A circuit according to claim 1, characterised in that said memory points are identical memory points, mounted in phase opposition.

3. A circuit according to any one of claims 1 and 2, characterised in that said reset to zero means are controlled in such a way as to position said circuit in a pre-set state when it is initialised, and to interrupt the generation of a pulse as soon as one of said input signals takes a pre-set value.

4. A circuit according to any one of claims 1 to 3, characterised in that:
means of resetting said first memory point to zero are controlled by said inverted command signal;
means of resetting said second memory point to zero are controlled by said control signal.

5. A circuit according to any one of claims 1 to 4, characterised in that said memory points each include two looped inverters, followed by a third inverter supplying said memory point output.

6. A circuit according to any one of claims 1 to 5, characterised in that access to each of said memory points is via a Nmos/Pmos pass gate.

7. A circuit according to any one of claims 2 to 6, characterised in that said reset to zero means include a Nmos transistor.

8. A circuit according to any one of claims 1 to 7, characterised in that said time-delay module is activated by a rising edge at the output of said second memory point.

9. A circuit according to claim 8, characterised in that said time-delay module includes an inverter time-delay element, a NAND gate and an inverter, delivering said pulse.

10. A micro-electronic component, characterised in that it includes at least one micro-electronic pulse generator circuit according to any one of the claims 1 to 9.

11. A micro-electronic component according to claim 10, characterised in that at least one of said circuits controls read and/or write memory access.
